(19) United States
(12) Patent Application Publication
(10) Pub. No.: US 2024/0428552 A1
(43) Pub. Date: Dec. 26, 2024

(54) IMAGE PROCESSING

(71) Applicant: Lemon Inc., Grand Cayman (KY)

(72) Inventors: Yegor Klochkov, London (GB); Yang Liu, Los Angeles, CA (US)

(21) Appl. No.: 18/821,791

(22) Filed: Aug. 30, 2024

(51) Int. Cl. G06V 10/44; G06T 7/10; G06V 10/764

(52) U.S. Cl. CPC G06V 10/44; G06T 7/10; G06V 10/764; G06V 2201/07

(57) ABSTRACT

There are proposed methods, devices, and computer program products for image processing. In the method, a reference dataset is obtained, the reference dataset comprising a plurality of reference samples, a reference sample in the plurality of reference samples comprising: a reference image and a reference label corresponding to the reference image, the reference label indicating a processing result of the image processing. An influence of the reference dataset on a loss is determined, the loss being used for updating an image model associated with the image processing based on the plurality reference samples. A hyperparameter is determined for updating the image model based on the influence of the reference dataset. The image model is updated based on the hyperparameter, the loss, and the plurality of reference samples. Therefore, the image model may be updated in an accurate and effective way.

### FIELD

The present disclosure generally relates to image processing, and more specifically, to methods, devices and computer program products for image processing based on a machine learning model.

### BACKGROUND

Machine learning models have seen many impressive results in the past years, however researchers and practitioners have little understanding what happens inside the models and how they learn to predict. There are various solutions to interpret the internal computations in a way understandable to humans, influence functions attempt to explain model behavior through data by attributing model predictions (or generations) to particular training examples. In the field of image processing, various models are trained for various image processing functions. The training dataset (also referred to as the reference dataset) may affect the training of the models and then the output of the trained models. Therefore, it is desired to measure the influence of the dataset and then adjust the training of the models.

### SUMMARY

In a first aspect of the present disclosure, there is provided a method for image processing. The method comprises: obtaining a reference dataset that comprises a plurality of reference samples, a reference sample in the plurality of reference samples comprising: a reference image and a reference label corresponding to the reference image, the reference label indicating a processing result of the image processing; determining an influence of the reference dataset on a loss for updating an image model associated with the image processing based on the plurality reference samples, the image model representing an association relationship between an image and a processing result of the image processing; determining a hyperparameter for updating the image model based on the influence of the reference dataset; and updating the image model based on the hyperparameter, the loss, and the plurality of reference samples.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates an example environment of a processing model according to the machine learning technique;

FIG. 2 illustrates an example diagram of image processing according to implementations of the present disclosure;

FIG. 3 illustrates an example diagram of obtaining hyperparameters according to implementations of the present disclosure;

FIG. 4 illustrates an example diagram of recommended hyperparameters according to implementations of the present disclosure;

FIG. 5 illustrates an example diagram of a comparison of influences of images according to implementations of the present disclosure;

FIG. 6 illustrates an example diagram of a comparison of convergences with difference batch sizes according to implementations of the present disclosure;

FIG. 7 illustrates an example diagram of paired sentences according to implementations of the present disclosure;

FIG. 8 illustrates an example diagram of similarity between the paired sentences according to implementations of the present disclosure;

FIG. 9 illustrates an example flowchart of a method for image processing according to implementations of the present disclosure; and

FIG. 10 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

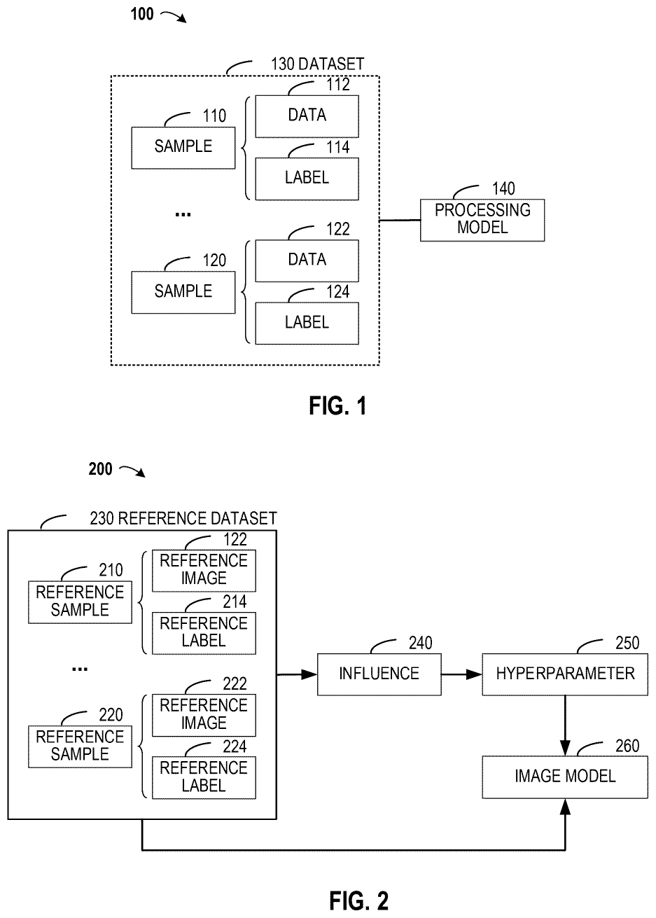

In order to measure the influence of the training dataset, an existing approach relies on the calculation of the inverse Hessian-vector products (iHVP), but the solver “Linear time Stochastic Second-order Algorithm” (LiSSA) is often deemed impractical for large models due to expensive computation and hyperparameter tuning. Referring to FIG. 1 for a brief of the working environment of the present disclosure, FIG. 1 illustrates an example environment 100 of a processing model according to the machine learning technique. In FIG. 1, a dataset 130 may be obtained for training a processing model 140. Here, the processing model 140 may be built based on a desired purpose. For example, in the image processing field, the processing model may be built for image processing such as image classification, or object detection, and the like. In another example, in the language processing field, the processing may be built for text processing such as rewriting an input text string (such as an article, a paragraph, a sentence, and the like) into an output text string with similar meaning, with different meaning, or with a different style, and the like.

The dataset 130 may include a plurality of samples 110, . . . , and 120, and each of the samples may comprise a data portion and a label portion. As shown in FIG. 1, the sample 110 may comprise data 112 and a label 114, . . . , the sample 120 may comprise data 122 and a label 124. Here, the samples are selected based on the purpose of the processing model 140. In the image processing field, supposing the processing model 140 aims at outputting a classification of the image, the data 112 may be an image and the label 114 may be a classification of image. In the language processing field, supposing the processing model 140 aims at outputting a similar sentence, the data 112 may be a sentence and the label 114 may be another sentence with similar meaning.

The following paragraph provides a brief of the present disclosure. In the present disclosure, three hyperparameters—the scaling factor (also referred to as the step size), the batch size, and the number of steps, can be chosen depending on the spectral properties of the Hessian, particularly, its trace and the largest eigenvalue. By evaluating with random sketching, it is found that the batch size has to be sufficiently large for LiSSA to converge. However, for all of the models the requirement is mild. In the present disclosure, the findings are confirmed empirically by comparing to Proximal Bregman Retraining Functions (PBRF). Finally, the role of the inverse Hessian play is discussed in calculating the influence.

Influence functions are built for attributing model's output to training data. Some solutions introduce Hessian-based influence functions in order to approximate the effect of removal of one training point from the training set (referred to as leave-one-out retraining). The formula for influence calculation is derived from the second-order Taylor approximation of the loss, thus the Hessian and the gradient of the training point are sufficient for calculation. Some solutions demonstrate various applications of influence functions such as explaining model outputs through data attribution, repairing mislabeled data, and backdoor attacks.

Some solutions criticize influence functions for poor approximation of leave-one-out retraining as depth and width of neural networks increase. As a solution, it is proposed two fixes: replace the Hessian (that possibly has negative eigenvalues) with well-behaved Gauss-Newton Hessian Martens, and replace the leave-one-out retraining (which itself is not a well-defined objective) with Proximal Bregman Retraining Functions (PBRF). They demonstrate that the latter do not suffer from the randomness introduced by model initialization and data sampling, and they argue can serve as gold standard when evaluating influence function approximation methods. The disclosure focuses on this particular formulation of influence functions, where the Hessian is replaced with Gauss-Newton Hessian, and the PBRF serves as the ground truth in validation.

The calculation of influence functions requires approximation of inverse Hessian-vector products. Given the dimension of modern deep models and the size of the training dataset, it can be a hard problem. As an alternative to traditional conjugate gradient method, it is proposed a stochastic iterative approach called “Linear time Stochastic Second-Order Algorithm”, or in short LiSSA. This algorithm requires to calculate a sampled Hessian vector product at each iteration, the batch size per sample can be as little as just one training point. There are two additional hyperparameters involved the scaling factor and the number of steps in LiSSA, with little direction of how to choose them in practice. Some solutions tackle LiSSA, suggesting that they lack convergence for deep networks with a large number of parameters, in particular, the method deemed impractical due to the need for expensive hyperparameter search.

The present disclosure carefully analyzes the convergence of LiSSA and find that the choice of all three hyperparameters, including the batch size, depends on the properties of the Gauss-Newton Hessian, namely, its trace and largest eigenvalue. Since the size of the Hessian is very large (number of parameters to square), the disclosure evaluates these two statistics with random sketching, which only requires estimation of Hessian-vector products in the process, the disclosure reports these statistics and the corresponding requirements for some open-sourced vision and language models. Further, contrary to common belief, the batch size has to be sufficiently large for the algorithm to converge. However, this is a mild requirement, and particularly for language models, it is redundant.

Some solutions attempt to avoid calculating inverse Hessian vector products have been made in the literature. Some solutions suggest truncating the spectrum of the Hessian. When it comes to language models, most of the recent literature is using gradient-based influence functions. These are typically focused on the finetuning stage and often this choice is motivated by simpler and faster implementation. The exception is the influence of pretraining data and analysis is restricted to MLPs of the transformer. In addition, they impose a block-wise structure on the Hessian. Although such structural assumptions are not advocate against, the disclosure suggests that running the plain and model-agnostic LiSSA can be feasible, given that the hyperparameter search is avoided. The implementation allows models that are distributed with tensor parallelism, which can have up to 20B parameters when used with 8 GPUs on one node.

Referring to FIG. 2 for a brief of the present disclosure, FIG. 2 illustrates an example diagram 200 of image processing according to implementations of the present disclosure. As shown in FIG. 2, a reference dataset 230 may be obtained, here the reference dataset 230 may comprise a plurality of reference samples, and a reference sample in the plurality of reference samples may comprise: a reference image and a reference label corresponding to the reference image, the reference label indicating a processing result of the image processing. Then, an influence 240 of the reference dataset may be determined, the influence 240 may affect a loss for updating an image model 260 associated with the image processing based on the plurality reference samples. Here, the image model 260 represents an association relationship between an image and a processing result of the image processing. Further, based on the influence 240 of the reference dataset 230, a hyperparameter 250 may be obtained for updating the image model 260, and then the image model 260 may be updated based on the hyperparameter, the loss, and the plurality of reference samples. In other words, the image model 260 may be trained based on the determined hyperparameter 250. Here, the hyperparameter 250 may comprise any of: a step size, a batch size, and the number of steps (i.e., the convergence criterion) for training the image model 260.

As the plurality of reference samples affect the image model with different weights, performance of the image model may vary when the hyperparameter(s) are set to different values during the training. With implementations of the present disclosure, the influence of the dataset may be determined and then the hyperparameter may be set in a more accurate way, so as to increase the performance of the image model.

The follow paragraphs will provide some background knowledge of the influence functions. For the sake of description, the present disclosure will describe details of the image processing by taking the image classification as an example of the image processing. Alternatively and/or in addition, the image processing may include other tasks such as object detection and the like.

In implementations of the present disclosure, in order to determine the influence of the reference dataset on the loss, a reference matrix may be obtained based on the reference dataset, the reference dataset comprising a plurality of dimensions corresponding to the plurality of reference samples respectively, a dimension in the plurality of dimension comprising: an image feature corresponding to the reference image comprised in the reference sample and a label feature corresponding to the reference label comprised in the reference sample. A spectral property related to the reference matrix may be determined, the spectral property comprising any of: a trace related to the reference matrix or an eigenvalue related to the reference matrix. Then, the influence of the reference dataset may be determined based on the spectral property of the reference matrix.

Usually, influence functions are calculated based under the assumption that the optimized parameter θ of the model delivers minimum to the training loss,

$${θ}^{*} = arg {min}_{θ} \frac{1}{\vert {D}_{tr} \vert} {\sum }_{( x , y ) ∈ {D}_{t r}} ℓ ( x , y ; θ ) \qquad ( 1 )$$

Here, [symbol] ₜᵣ represents the reference dataset and it includes multiple dimensions. The reference sample is represented as a pair (x,y), i.e., the input and label pair, and for the image classification task, each pair consists of an image and a classification of the image. That is, the dataset [symbol] ₜᵣ consists of pairs x=image and y=label. For the language processing task, each pair consists of context and next word token. That is, given a sequence s=(s₁, . . . , sₜ), the dataset [symbol] ₜᵣ consists of pairs x=(s₁, . . . , sₜ₋₁) and y=sₜ.

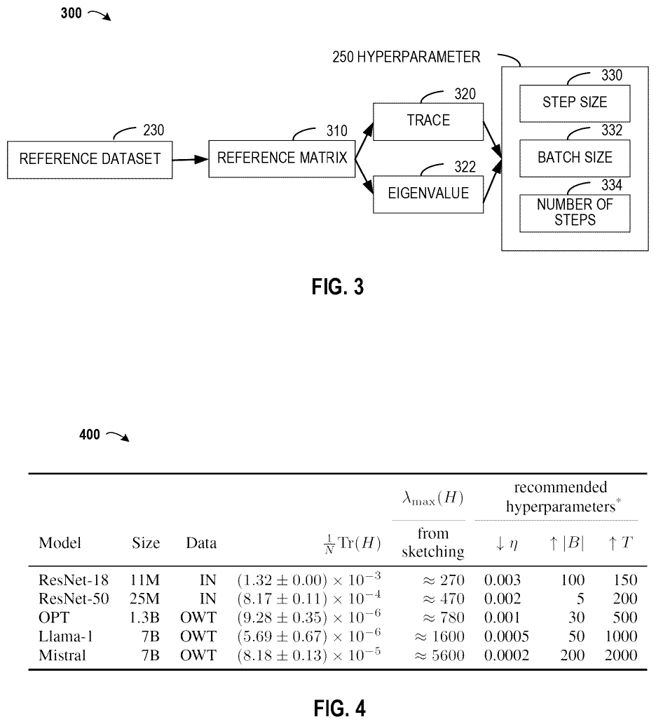

FIG. 3 illustrates an example diagram 300 of obtaining hyperparameters according to implementations of the present disclosure. As shown in FIG. 3, a reference matrix 310 may be obtained based on the reference dataset 230, and then the spectral property (for example, a trace 320 and/or an eigenvalue 322) may be determined from the reference matrix 310. Next, the hyperparameter 250, for example, at least one of a step size 330, a batch size 332, and the number of the steps 334 may be determined.

The following paragraphs will provide more details about determining the influence. Fix a point (xₘ,yₘ)∈Dₜᵣ, and for a small perturbation weight ϵ>0 consider:

$${θ}^{*} ( ϵ ) = arg {min}_{θ} \frac{1}{\vert {D}_{tr} \vert} {\sum }_{( x , y ) ∈ {D}_{t r}} ℓ ( x , y ; θ ) + ϵℓ ( {x}_{m} , {y}_{m} ; θ ) \qquad ( 2 )$$

Then, the influence of training point (xₘ,yₘ) on the parameter is denoted as:

$${𝒥 ( ( {x}_{m} , {y}_{m} ) ) = \frac{d {θ}^{*} ( ϵ )}{d ϵ} \vert}_{c = 0} = - {H}^{- 1} ∇ ℓ ( {x}_{m} , {y}_{m} ; {θ}^{*} ) \qquad ( 3 )$$

Here, the reference matrix may be represented as H, which denotes the population Hessian, that is:

$$H = \frac{1}{\vert {𝒟}_{tr} \vert} {\sum }_{( x , y ) ∈ {𝒟}_{tr}} {∇}^{2} ℓ ( x , y ; {θ}^{*} )$$

Furthermore, the spectral property related to the reference matrix may be determined, and then the influence may be represented by the spectral property. With these implementations, the purpose of determining the influence is converted into a calculation of the spectral property, and thus the influence may be determined in an accurate way based on mathematics computation.

In implementations of the present disclosure, in order to obtain the reference matrix based on the reference dataset, a plurality of influences of the plurality of reference samples on the loss may be determined respectively, and then the reference matrix related to the dataset may be determined based on the plurality of influences of the plurality of reference samples. Supposing there is a set a predictions zₜₑₛₜ=(xₜₑₛₜ,ŷₜₑₛₜ), and let f((x,y),θ)=log p(y|x;θ) are the log probability according to the trained model. Then, the influence of training point zₜᵣₐᵢₙ=(xₘ,yₘ) on the prediction zₜₑₛₜ is denoted as:

$$𝒥 ( {z}_{train} , {z}_{test} ) = - ∇ {f ( {z}_{test} , θ )}^{T} {H}^{- 1} ∇ ℓ ( {x}_{m} , {y}_{m} ; {θ}^{*} )$$

For language models, the calculation of the influence for completion following the existing solution. Let s=(s₁, . . . , sₚ) be a prompt an ŝ=(ŝ₁ . . . ŝ_{c}) be a completion. Then, the influence for average log-probability of predicted tokens is calculated:

$$f ( s , \hat{s} ; θ ) = \frac{1}{c} {\sum }_{j = 1}^{c} log p ( {\hat{s}}_{j} \vert {s}_{1} … {s}_{p} {\hat{s}}_{1} … {\hat{s}}_{j - 1} ; θ )$$

In the present disclosure, PBRF may work as ground truth. The inverse problem H⁻¹∇ [symbol] (zₜᵣₐᵢₙ;θ) can be difficult to perform due to degenerate eigenvalues of H. It is proposed to use a damping parameter λ>0 and instead invert a regularized matrix (H+λI)⁻¹ However, such matrix can still be degenerate due to possibly negative eigenvalues of the Hessian of a non-convex loss, which are indeed observed in practice. Motivated by classical natural descent methods, it is proposed to replace it with Gauss-Newton Hessian (GNH), which is denoted as follows. Suppose that the loss has the form:

$$ℓ ( ( x , y ) ; θ ) = ℓ ( h ( x ; θ ) , y ) , ℓ ( h , y ) = - log ( {sf ( h )}_{y} )$$

Here, h(x;θ)∈ [symbol] ^{K} is the logit function and

$${sf ( h )}_{j} = \frac{exp ( {h}_{j} )}{{\sum }_{j = 1}^{K} exp ( {h}_{j} )}$$

is the standard softmax function. Then, the GNH has the form:

$$H = \frac{1}{\vert {𝒟}_{tr} \vert} {\sum }_{( x , y ) ∈ {𝒟}_{tr}} [ {J}_{θ} h ( x ; θ ) ] {∇}_{h}^{2} {ℓ ( h ( x ; θ ) , y ) [ {J}_{θ} h ( x ; θ ) ]}^{T}$$

For the Cross-Entropy loss, there is the identity ∇ₕ² [symbol] (h(x;θ),y)=Diag(sf(h))−sf(h)sf(h)^{T}. Furthermore, it shows that if the Hessian is replaced with the Gauss-Newton Hessian, the influence functions (3) approximate a different retraining functions called Proximal Bregman Retraining Functions (PBRF). These functions correspond to retraining of the Proximal Bregman Objective (PBO) on training point (xₘ,yₘ) reads as follows:

$${θ}_{PBRF} ( ϵ ) = arg {min}_{θ} \frac{1}{\vert {𝒟}_{tr} \vert} {\sum }_{( x , y ) ∈ {𝒟}_{tr}} D ( h ( x ; θ ) , h ( x ; {θ}^{*} ) , y ) + ϵℓ ( ( {x}_{m} , {y}_{m} ) ; θ ) + \frac{λ}{2} {‖ θ - {θ}^{*} ‖}^{2} \qquad ( 5 )$$

Here, D(h,h′,y)=(h,y)− [symbol] (h′,y)− [symbol] (h−h′)^{T}∇ₕ [symbol] (h′,y) is the Bregman divergence. Comparing PBO with the objective in (2), the proximity penalty λ/2∥θ−θ*∥² takes into account the damping parameter, while replacing the loss with the Bregman divergence accounts for potential lack of convergence, i.e. it no longer needs to assume that the training of the original parameter converges to global minimum of the loss as in (1). In addition, it finds that PBRFs are a more reliable objective compared to traditional retraining, which is known to produce different outputs.

PBRF is suitable ground truth objective for validation of influence function estimation algorithms. For instance, it is used for empirical confirmation of the ad-hoc algorithm. PBRF is referred as a ground truth influence in order to confirm the proposed solution.

Regarding iterative inverse Hessian-vector products, for calculating these inverse Hessian-vector products (iHVP) of form u=(H+λ)⁻¹_{g}, it is proposed to use a variant of Linear time Stochastic Second-Order Algorithm, that consist of the iterations:

$${u}^{t} = g + ( I - η ( {\tilde{H}}^{t} + λ ) ) {u}^{t - 1} , t = 1 , … , T$$

Here, \tilde{H}^{t} is an in-batch estimate of H. Ideally, the scaling parameter η>0 needs to be chosen to ensure that ηH is a contraction, however, it requires knowing the largest eigenvalue of H. To this day, LiSSA is often discarded due to its hyperparameters, which are not trivial to tune when one does not have a clear objective. In particular, the three hyperparameters, i.e., η, T, and the batch size B, are often chosen without any directive, and the resulting estimate is deemed unreliable.

The LiSSA updates (6) are equivalent to stochastic gradient descent (SGD) with step size η for the quadratic objective

$${min}_{u} \frac{1}{2} {u}^{T} ( H + λ ) u - {u}^{T} g .$$

In theory, mini-batch SGD is known to work at least as well as full gradient, even in terms of number of updates. However, larger batch sizes are often preferred by practitioners. The problem stems from theoretical results relying on a notion of uniform smoothness, which is not observed in practice, where an in-batch function is usually not as smooth as the average over the whole dataset. Furthermore, optimal choice of step size η and the number of steps T depend on the largest eigenvalue of the Hessian λₘₐₓ(H). Rather than conducting hyperparameter tuning, the largest eigenvalue λₘₐₓ(H) is evaluated directly, which allows us to run the LiSSA only once per test request.

Hessian-vector products. The updates (6) involve calculation of in-batch Hessian-vector products \tilde{H}ₜu. Expanding the expression for GNH (4), for a batch of data B={(x,y)}, there is:

$${\tilde{H}}_{t} u = \frac{1}{\vert B \vert} {\sum }_{( x , y ) ∈ B} [ {J}_{θ} h ( x ; θ ) ] {∇}_{h}^{2} {ℓ ( h ( x ; θ ) , y ) [ {J}_{θ} h ( x ; θ ) ]}^{T} u \qquad ( 7 )$$

Here, [J_{θ}h(x;θ)]^{T}u is a directional derivative of vector-function h(x;θ). Calculating the directional derivatives per each example in the batch precisely may be prohibitively expensive. Instead, it is approximated by finite differences:

$${{[ {J}_{θ} h ( x ; θ ) ]}^{T} u = \frac{d}{d δ} h ( x ; θ + δu ) \vert}_{δ = 0} \approx \frac{h ( x ; θ + δ u ) - h ( x ; θ - δ u )}{2 δ}$$

Here δ is a small value, which is fixed to δ=0.01 in the experiments. Then, the in-batch GNH-vector product is approximated by using three forward propagations and one backward propagation:

$${\tilde{H}}_{t} u \approx {∇}_{θ} \frac{1}{\vert B \vert} {\sum }_{( x , y ) ∈ B} {h ( x ; θ )}^{T} {S}_{h} \{ \frac{h ( x ; \dot{θ} + δ u ) - h ( x ; \dot{θ} - δ u )}{2 δ} \}$$

Here, \dot{θ} indicates not to calculate the derivative through this parameter, and Sₕ=Diag(sf(h))−sf(h)sf(h)^{T} is also fixed. Thus, it is simply back-propagated through a weighted sum of logits in the batch h(x;θ), with weights depending on the matrices Sₕ and finite differences (h(x;\dot{θ}+δu)−h(x;\dot{θ}−δu))/(2δ). The latter two can be calculated in a gradient free manner with three forward propagations.

Regarding convergence of LiSSA and choice of hyperparameters, in order to carefully analyze the convergence of LiSSA iterations (6), it is reformulated as SGD updates. Observe that the result of iHVP applied to a gradient g, u*=(H+λ)⁻¹ g, delivers minimum to the following objective:

$${u}^{*} = arg {min}_{u} L ( u ) , L ( u ) : = \frac{1}{2} {u}^{T} H u + \frac{λ}{2} {‖ u ‖}^{2} - {u}^{T} g \qquad ( 8 )$$

With appropriate scaling, the LiSSA updates are equivalent to SGD with step size η and the gradient calculated on in-batch loss \tilde{L}ₜ(u), where the Gauss-Newton Hessian H is replaced with unbiased estimate \tilde{H}ₜ calculated over a random batch, turning the updates in (6) into:

$${u}^{t} = {u}^{t - 1} - η [ ( {\tilde{H}}^{t} + λ ) {u}^{t - 1} - g ] , t = 1 , … , T$$

Here, the scaling parameter in (6) now plays the role of a learning rate. Convergence of SGD is well studied in the literature, with the recommending step size η typically depending on the smoothness of L(u), which equals to λₘₐₓ(H). Although in theory, mini-batch SGD is generally considered more efficient than full-batch, in practice mini-batch SGD often performs poorly due to the difference in smoothness of the population objective L(u) and the in-batch objective \tilde{L}(u) as pointed out. Instead, they formulate their bounds in terms of expected smoothness of \tilde{L}ₜ(u). The disclosure derives the following: results that takes into account this difference for the quadratic optimization (8).

Theorem 1. Suppose.η<1/(λₘₐₓ(H)+λ).Then, there is the convergence in-expectation:

$$‖ {Eu}^{t} - {u}^{*} ‖ \leq {( 1 - λ η )}^{t} ‖ {u}^{0} - {u}^{*} ‖ .$$

Furthermore, assume that η>0, δ∈(0,1), such that

$${( 1 - η ( H + λ ) )}^{2} + {η}^{2} ( E {\tilde{H}}_{t}^{2} - {H}^{2} ) ≼ ( 1 - δ ) I \qquad ( 9 )$$

$$Then ,$$

$$E {‖ {u}^{t} - {u}^{*} ‖}^{2} \leq {( 1 - δ )}^{t} ( 2 {‖ {u}^{0} - {u}^{*} ‖}^{2} + {‖ {u}^{*} ‖}^{2} ) + {δ}^{- 1} {η}^{2} \tilde{Δ}$$

Here \tilde{Δ}=E∥(H−\tilde{H}ₜ)u*∥² is interpreted as a sampling error. Although the updates of LiSSA are designed to be unbiased, it is not always guaranteed to converge even if η<1/λₘₐₓ(H). A counter-example where the difference E∥u^{t}−u*∥² is not guaranteed to converge whenever the requirement (9) does not hold. The principal difference comes from the matrix E\tilde{H}ₜ²−H², which can be interpreted the sampling gap, i.e. the larger the batch size, the closer the sampled squared Hessian is to the population squared Hessian. In particular, as the batch size is increased |B|→∞, sooner or later it is expected to have that E\tilde{H}ₜ²≈H². Thus, the batch size has direct impact on the convergence of LiSSA. Although it is hard to assess the inequality (9) directly, in many cases the following simple condition is relied on:

$$E {\tilde{H}}_{t}^{2} - {H}^{2} ≼ \frac{C}{\vert B \vert} Tr ( H ) H \qquad ( C \text{.1} )$$

Here |B| is the batch size, which for language models corresponds to the total in-batch number of tokens. For simplicity, assuming this number to be the same in each batch. C works as a constant moderately larger than 1, e.g. C=2.

In particular, this condition to hold for classification with independent sampling (assuming certain properties of the gradients' distribution). For the case of language modeling, the batch consists of tokens sampled per sequence. The condition holds if the gradients corresponding to different tokens within the same sequence have (mostly) little correlation. This is reasonable to expect due to the large dimension of the parameter, and a similar assumption appears in in the context of imaging inverse problems. In addition, a simple empirical test is provided to compare the traces of LHS and RHS in (C.1), and it confirms the inverse scaling with batch size for both classification and language modeling tasks.

Under condition C.1, Theorem 1 is rewritten in a simplified form with an exact requirement for a sufficiently large batch size.

Corollary 1. Suppose that C.1 holds. The hyperparameters are chosen:

$$η = \frac{1}{( {λ}_{max} ( H ) + λ )} \qquad ( 10.1 )$$

$$\vert B \vert \geq CTr ( H ) / {λ}_{max} ( H ) \qquad ( 10.2 )$$

$$Then ,$$

$$E {‖ {u}^{t} - {u}^{*} ‖}^{2} ≲ {( 1 - λ η )}^{2 t} ( {‖ {u}^{0} ‖}^{2} + {‖ {u}^{*} ‖}^{2} ) + \frac{{η}^{2} Tr ( H )}{\vert B \vert} {{g}^{⊤} ( H + λ )}^{- 1} g .$$

Here, the algorithm converges in T steps:

$$T = Ω ( 1 / ( η λ ) ) \qquad ( 10.3 )$$

In implementations of the present disclosure, the hyperparameter may comprise a step size for updating the image model, and determining the step size comprising: determining a first and a second eigenvalue related to the reference matrix, the first eigenvalue being greater than the second eigenvalue; and determining the step size based on the first eigenvalue. Specifically, the step size η may be determined based on (10.1), where H represents the Hessian matrix, and λₘₐₓ(H) represents a maximum one in a plurality of eigenvalues of H. For example, two or more eigenvalues may be determined and then the maximum one may be used for determining the step size. λ represents a damping parameter, which may be omitted in some implementations. At this point, the step size depends on

$$\frac{1}{{λ}_{max} ( H )} .$$

With these implementations, the step size may be determined in an easy and effective way, and then the models (such as the image model and the language model) may be updated in a direction for minimizing the loss with an appropriate step size.

In some implementations of the present disclosure, the damping parameter may be considered. Specifically, the step size may be updated by the damping parameter, and the damping parameter may be greater than zero. With these implementations, the step size may be determined from an appropriate range based on the damping parameter. Therefore, more variable factors that may affect the training are considered, so as to increase the performance of the trained model.

In implementations of the present disclosure, the hyperparameter may comprise a batch size for updating the image model. In order to determine the batch size, a trace related to the reference matrix may be determined, and then the batch size may be obtained based on the trace and the first eigenvalue related to the reference matrix. Specifically, the batch size may be determined according to (10.2), where Tr(H) represents a trace of H, and C represents a constant moderately larger than 1, e.g., C=2.

In implementations of the present disclosure, the hyperparameter may comprise a number of steps for updating the image model. Further, the number of steps may be determined based on the step size and a damping parameter. Specifically, the number of steps may be determined according to (10.3). Here, η represents the step size and the number of steps T may be determined based on a reciprocal (for example, 1/η) of the step size. In some implementations, a damping parameter may be considered and then the number of steps may be determined based on 1/(ηλ). In some implementations, in order to mapping T into a suitable range, a mapping function Ω( ) may be selected and thus the number of steps may be determined in a more accurate way.

In the error bound above, the first term depends on the learning rate and the number of steps, and it measures how quickly it is converged to the solution, therefore it is labelled as convergence error. The second term depends directly on the batch size and it is labelled as sampling error. It does not depend on the number of steps performed and comes from the difference between the sampled HVP and population HVP. In particular, it is trivial to see that it corresponds to the variance of a single update, E∥u^{t}−E[u^{t}|u^{t}−1]∥², in the limit u^{t}→u*. Notice that although the convergence error does not depend on the batch size explicitly, the condition |B|≥CTr(H)/λₘₐₓ(H) should be satisfied in order to converge.

Remark: Notice that Theorem 1 can hold for arbitrary matrix H and its sampling counterpart, such as the original Hessian E∇² [symbol] (z;θ), and arbitrary unbiased estimates \tilde{H}^{t}, assuming the batches are drawn independently of each other and from the same distribution. However, condition (C.1) and, correspondingly, Corollary 1 are only expected to hold for the Gauss-Newton Hessian.

FIG. 4 illustrates an example diagram 400 of recommended hyperparameters according to implementations of the present disclosure. As shown in FIG. 4, ResNet-18 and ResNet-500 relate to image models, and OPT, Llama-1 and Mistral relate to language models. The table shows Gauss-Newton-Hessian statistics and recommended hyperparameters. Statistics are calculated on ImageNet (IN) on vision and Open-Web-Text-2 (OWT) on language models. The arrow ⬆ indicates a lower bound, and ⬇ indicates that it is an upper bound. Assuming C=2 in C.1, and λ=5.0, T=2/(ηλ) for sake of demonstration.

Empirical analysis of eigenvalue statistics. It is apparent that to choose hyperparameters correctly, it needs to evaluate the statistics λₘₐₓ(H) and Tr(H). Since there is no way to calculate the Hessian explicitly, the disclosure resorts to random feature methods that only require evaluation of HVPs.

Evaluating the trace is straightforward. a series of quadratic forms (gᵢ^{T}\tilde{H}ᵢgᵢ)_{g}_{ᵢ₌₁}^{N} is generated, which consists of calculating HVPs and dot products for Gaussian vectors

$$g ∼ N ( 0 , \frac{1}{N} I ) .$$

Their mean estimates the trace

$$E {g}^{⊤} \tilde{H} g = {Eg}^{⊤} Hg = \frac{1}{N} Tr ( H ) .$$

Due to independence of observations, standard error of this estimator is evaluated. For evaluating the largest eigenvalue, random sketching is used. That is, the matrix is evaluated as Ĥ=ΦHΦ^{T}, with Φ∈ [symbol] ^{d×N} generated in a way such that

$${Φ}_{ij} ∼ N ( 0 , \frac{1}{d} ) .$$

It is known, such sketches can evaluate the top eigenvalues of the original matrix

$${\hat{λ}}_{i} ( H ) = {λ}_{i} ( \hat{H} ) - \frac{Tr ( \hat{H} )}{d}$$

(Swartworth and Woodruff, 2023), with error of estimation negligible for the top eigenvalue.

The results of these evaluations are shown in the table for 2 ResNets (ResNet-18 and ResNet-50) and 3 open-sourced language models (OPT, Llama-1, and Mistral). The disclosure also shows recommendations for the choice of hyperparameters based on Corollary 1. Notice that contrary to the original idea of SGD, in all cases the recommended batch size is larger than 1. However, recall that for language modeling, the batch size is the amount of tokens in a batch, and the recommended values are smaller than a typical context length. Thus, the LiSSA can work with just one sequence per batch. The recommendation is only a lower bound that ensures that LiSSA does not diverge, and increasing the batch size further makes the sampling error smaller (in (10.2)).

In implementations of the present disclosure, once the above hyperparameters are determined, the image model may be updated according to one or more of the hyperparameters. Specifically, a batch of reference samples from the plurality of reference samples based on the batch size, and then with respect to a target reference sample in the batch of reference sample, a prediction of a processing result related to a target image comprised in the target reference sample may be determined based on the image model. A reference loss value may be determined based on the prediction and a target label comprised in the target reference sample, and then the image model may be updated based on the reference loss value.

For the image classification task, a batch of image and classification pairs (x,y) may be selected, where the number of pairs in the batch equals to the batch size. Then, the image x may be inputted into the image model (with parameters θ), and the image model may output a prediction of a classification of the image. The loss may be determined, and then the parameters of the image model θ may be updated to θ* according to (1).

In some implementations of the present disclosure, the image model may be updated in a direction for decreasing the reference loss value according to the step size as determined from (2). With these implementations, the batch size and step size may increase the performance of the training, and thus the image model maybe trained towards a direction for minimizing the loss. Therefore, the image model may output a classification of the inputted image in a more accurate way.

In implementations of the present disclosure, the determined number of steps may help to determine whether the trained image model meets a convergence criterion. Specifically, during updating the image model, a number of iterations that the image model is updated may be determined, and the training procedure may continue in response to determining that the number of iterations being below the number of steps. In other words, the image model may be updated until the iterations reaches the number of steps T. With these implementations, the training procedure may be stopped in time once an acceptable accuracy level is met.

Although the present disclosure describes details of the image processing by taking the image classification as an example, alternative and/or in addition, the image processing comprises any of: image classification, image analysis, image enhancement, image segmentation, object detection, image style conversation, and image generation. Specifically, in the image analysis field, an image analysis model may be built for analyzing the content of the image. At this point, the sample in the reference dataset may include an image and an analysis result of the image (for example, a text string and the like). Based on the above steps, an influence may be determined based on the reference dataset, and then the step size, the batch size, and the number of steps may be determined based on the influence for training the image analysis model.

In the image enhancement field, an image enhancement model may be built for enhancing the inputted image. At this point, the sample in the reference dataset may include an image and an enhanced image. Based on the above steps, an influence may be determined based on the reference dataset, and then the step size, the batch size, and the number of steps may be determined based on the influence for training the image enhancement model. With these implementations of the present disclosure, various image models may be trained for implementing various tasks in an accurate and effective way.

In the image segmentation field, an image segmentation model may be built for segment the inputted image. At this point, the sample in the reference dataset may include an image and a segmented image. Based on the above steps, an influence may be determined based on the reference dataset, and then the step size, the batch size, and the number of steps may be determined based on the influence for training the image segmentation model. With these implementations of the present disclosure, various image models may be trained for implementing various tasks in an accurate and effective way.

In the object detection field, an object detection model may be built for detecting object(s) in the inputted image. At this point, the sample in the reference dataset may include an image and object(s) detected in the image (for example, represented by a bounding box, or a mask). Based on the above steps, an influence may be determined based on the reference dataset, and then the step size, the batch size, and the number of steps may be determined based on the influence for training the object detection model. With these implementations of the present disclosure, various image models may be trained for implementing various tasks in an accurate and effective way.

In the image style conversation field, an image style conversation model may be built for converting the style of the inputted image. At this point, the sample in the reference dataset may include a first image with a first style (such as a cartoon style) and a second image with a second style (such as a sketch style). Based on the above steps, an influence may be determined based on the reference dataset, and then the step size, the batch size, and the number of steps may be determined based on the influence for training the image style conversation model. With these implementations of the present disclosure, various image models may be trained for implementing various tasks in an accurate and effective way.

In the image generation field, an image generation model may be built for generating an image. At this point, the sample in the reference dataset may include a text string and an image generated based on the text string. Based on the above steps, an influence may be determined based on the reference dataset, and then the step size, the batch size, and the number of steps may be determined based on the influence for training the image generation model. With these implementations of the present disclosure, various image models may be trained for implementing various tasks in an accurate and effective way.

Empirical validation is conducted for the theoretical results. Firstly, the disclosure aims to demonstrate that when the parameters are chosen according to Table 1, the LiSSA converges as expected. For ground truth, the disclosure calculates PBRF for selected training examples. Secondly, the disclosure aims to empirically confirm that the requirement on sufficiently large batch size is indeed important.

The disclosure compares LiSSA and PBRF for the ResNet-18 and ResNet-50 models and randomly selected 25 training and 500 test images from the ImageNet dataset. For each training image, it calculates iHVP sₜᵣₐᵢₙ=(H+λ)⁻¹∇ [symbol] (xₜᵣₐᵢₙ, yₜᵣₐᵢₙ) using LiSSA with hyperparameters from Table 1, and calculates the 500 influences sₜᵣₐᵢₙ^{T}∇ [symbol] (xₜₑₛₜ,yₜₑₛₜ). It also calculates the PBRF by finetuning the model with SGD on Proximal Bregman objective. For PBRF, it matches the batch size, number of steps, and the learning rate to LiSSA. It takes ϵ=1e-8 in (5) and optimizes the PBO using double precision to avoid float overflow. There are results for ResNet-18 and ResNet-50 for selected 5 images, and the full list is shown in the appendix, Section E. The disclosure observes three cases: 1) LiSSA approximates PBRF, i.e. scatter plot concentrates along the dashed line x=y; 2) both LiSSA and PBRF have very low values poorly distinguishable from zero; 3) both LiSSA and PBRF have high value and do not approximate each other. In the latter case, the PBO finetunning stirs away the model too far for the quadratic approximation to hold.

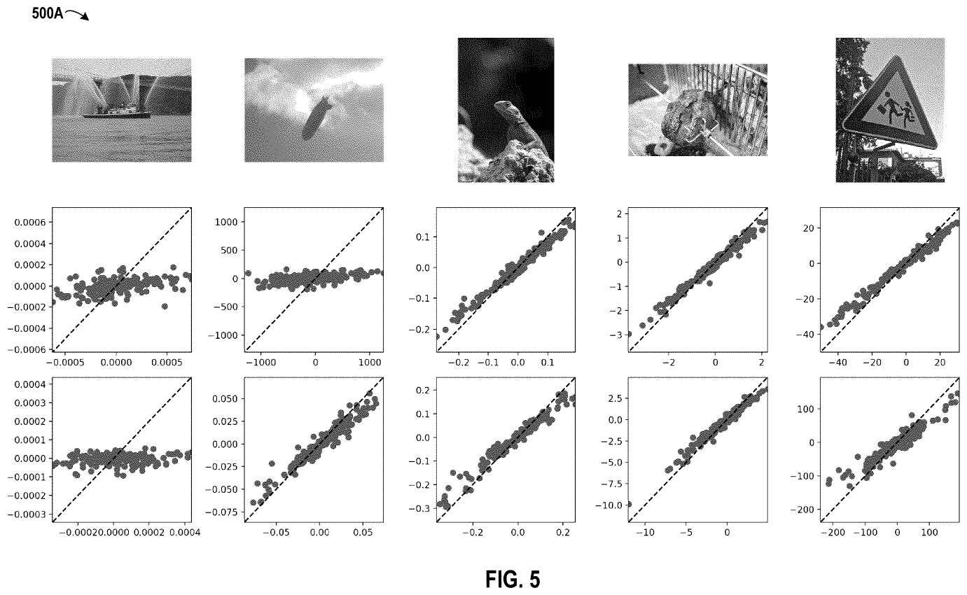

FIG. 5 illustrates an example diagram 500 of a comparison of influences of images according to implementations of the present disclosure. As shown in FIG. 5, a comparison of PBRF and LiSSA influences are provided. The first row shows five examples of training images. Below, the x-axis represents LiSSA influences, and the y-axis represents the PBRF influences corresponding to each training image and 500 test images. The second row is for ResNet-18, and the third row is for ResNet-50.

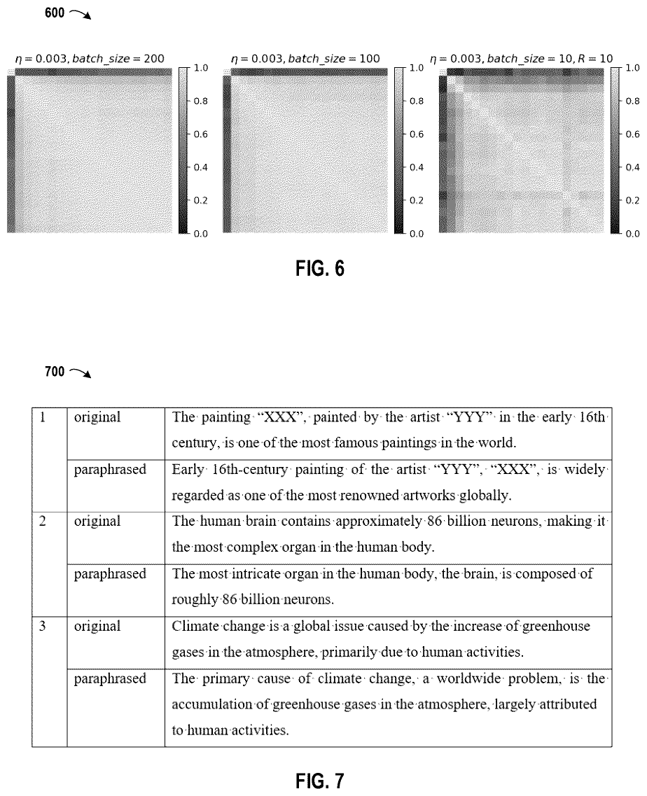

FIG. 6 illustrates an example diagram 600 of a comparison of convergences with difference batch sizes according to implementations of the present disclosure. As shown in FIG. 6, convergence of LiSSA is provided for ResNet-18 with different batch size configurations. The correlation is calculated between test influences at steps 1 . . . 1000 of LiSSA. The result for the small batch size of 10 is averaged over 10 trials, so that the amount of data used in the middle and rightmost figures is the same.

Furthermore, it is confirmed that the batch size matters not only for the sampling error in (10), but also for the speed of convergence. Let us take ResNet-18 with damping parameter and run the LiSSA algorithm for 1000 steps. According to the table in FIG. 4, the recommended batch size is equal to 100. It is suggested to consider three set-ups: batch size 2×larger than recommended, batch size is equal to 100, and batch size 10×smaller than recommended, with the result averaged over 10 independent runs. In the latter and the former cases, the result is obtained through iterating in the same amount of data, which allows to equalize the sampling error of a single update. FIG. 6 reports the correlation between influences calculated for 500 test images at different steps. The correlation converges to 1 faster for the two cases where the batch size is greater or equal to recommended 100, despite averaging over 10 trials for the small batch.

Regarding the role of inverted hessian, in the context of language models, the focus in the current literature is mostly on gradient-based influence functions. Often this choice is motivated by simpler and faster implementation. Due to the high cost of Hessian-based influence calculation, it is natural to ask what are the benefits compared to the gradient-based influence. The disclosure conducts a simple experiment in an attempt to understand what is left out of the consideration when relying only on gradient dot products.

Consider the eigenvalue decomposition of the Gauss-Newton Hessian H,

$$H = {\sum }_{j = 1}^{N} {λ}_{j} {v}_{j} {v}_{j}^{⊤}$$

Here vⱼ are orthogonal and normalized and Hvⱼ=λⱼvⱼ. For a gradient g=∇ [symbol] (zₜₑₛₜ) in this eigenbasis, the iHVP simply reweights the coefficient according to how large the eigenvalue is,

$$g = {\sum }_{j} ( g , {v}_{j} 〉 {v}_{j} , {λ ( H + λ )}^{- 1} g = {\sum }_{j} \frac{λ}{{λ}_{j} + λ} 〈 g , {v}_{j} 〉 {v}_{j} \qquad ( 11 )$$

It is known that for classification tasks what language models do per token, the Gauss-Newton Hessian is equivalent to a form of variance of the generated gradients ∇ [symbol] (ŷ|x), where ŷ˜p(y|x), which is referred to as Fisher Information Matrix (FIM). Generally speaking, this is different from the E_{z}_{ₜᵣₐᵢₙ}_{˜D}_{ₜᵣₐᵢₙ}∇ [symbol] (zₜᵣₐᵢₙ)∇ [symbol] (zₜᵣₐᵢₙ)^{T}. However, for low noise distributions the two might be used interchangeably. Such interpretation can help us to speculate, that the directions vⱼ corresponding to higher eigenvalues λⱼ are more likely to observe in the training gradients, in the sense that E [symbol] g,vⱼ [symbol] ² is higher.

$$\frac{λ}{{λ}_{j} + λ} \approx 0$$

for the top eigenvalues λⱼ that are much larger than the damping parameter λ. On the contrary, the lower eigenvalues receive

$$\frac{λ}{{λ}_{j} + λ} \to 1$$

$$as$$

$${λ}_{j} \to 0 .$$

In this sense, the iHVP works contrary to the traditional Principal Component Analysis, where the idea is to project the vector onto the top eigenvectors of the covariance. Instead, applying inverse Hessian removes the top directions corresponding to λⱼ>>λ and retains the directions corresponding to λⱼ>>λ.

For example, a plausible interpretation of the directions vⱼ would be that the top directions correspond to general language coherence, sentence structure, and keywords, while the directions with small eigenvalues could correspond to more specific, informative content. The disclosure proposes the following experiment to encourage such point of view. It considers ten pairs of sentences, one related to some historical or scientific fact, referred to as original, the other is a paraphrased version of the same fact, referred to as paraphrased. Some pairs are shown in FIG. 7, which figure illustrates an example diagram 700 of paired sentences according to implementations of the present disclosure. Although FIG. 7 only shows three paired sentences, more paired sentences may be included in the reference dataset.

For each pair of the sentences, the disclosure calculates the gradient of the next word prediction loss ∇ [symbol] (z) and calculates pairwise dot-influences ∇ [symbol] (z)^{T}∇ [symbol] (z′) and Hessian-based influences ∇ [symbol] (z)^{T}(H+λ)⁻¹∇ [symbol] (z′). The goal is to measure the similarities between original sentences, their rewritings, and their made-up derivatives. For this, it is proposed to measure the similarity by correspondingly normalizing with norms of gradients and self-influence:

$$Gradient - similarity ( z , {z}^{′} ) = \frac{∇ {ℓ ( z )}^{⊤} ∇ ℓ ( {z}^{′} )}{‖ ∇ {ℓ ( z )}^{⊤} ‖ ‖ ∇ ℓ ( {z}^{′} ) ‖}$$

$$Influence - similarity ( z , {z}^{′} ) = \frac{∇ {ℓ ( z )}^{⊤} {( H + λ )}^{- 1} ∇ ℓ ( {z}^{′} )}{\sqrt{∇ {ℓ ( z )}^{⊤} {( H + λ )}^{- 1} ∇ ℓ ( z )} \cdot \sqrt{∇ {ℓ ( {z}^{′} )}^{⊤} {( H + λ )}^{- 1} ∇ ℓ ( {z}^{′} )}}$$

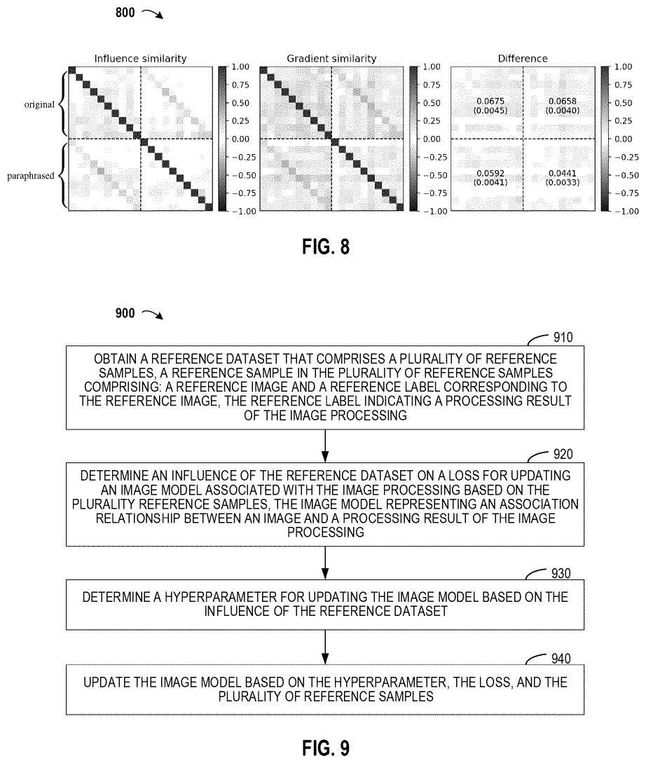

FIG. 8 illustrates an example diagram 800 of similarity between the paired sentences according to implementations of the present disclosure. As shown in FIG. 8, the left figure shows influence similarity calculated with LiSSA, middle-gradient similarity, right—the difference between the former and the latter. In the rightmost figure the numbers show the mean over each 10×10 square, with standard error in the brackets. It uses OPT 1.3B model, with λ=5.0, T=1000 and η=0.003. It uses a batch size of 4 sequences, each consisting of 512 tokens.

It is shown the pairwise similarities between the sentences. In the rightmost graph, it also shows the difference between gradient similarity and influence similarity. Unrelated sentences generally have higher gradient similarity than influence similarity since the values in the rightmost graph are mostly positive. As a result, the influence similarity between an original sentence and a rewritten one appears to be consistently higher than between unrelated sentences.

Downweighting directions that are more likely to observe in (11) can also be compared to the idea of the TF-IDF index, where the terms are reweighted according to their inverse frequency. Incidentally, it is shown that for a bag-of-words model (which although trivial, is also a language model), the influence functions correspond to a particular form of the TF-IDF index.

In summary, the hyperparameters for classical LiSSA approach for the calculation of inverse Hessian vector products can be chosen based on two spectral statistics of the Gauss-Newton Hessian: trace and largest eigenvalue. This also includes the batch size used for sampling the Hessian-vector products per update. It has to be sufficiently large, otherwise the LiSSA might not converge (shown empirically and theoretically). Therefore, despite the bad reputation of LiSSA when applying to large models, without the need for hyperparameter tunning it can be usable, with applications for models up to 7B possible with the implementation. With implementations of the present disclosure, machine learning models may be trained in an accurate and effective way.

The above paragraphs have described details for the image processing. According to implementations of the present disclosure, a method is provided for image processing. Reference will be made to FIG. 9 for more details about the method, where FIG. 9 illustrates an example flowchart of a method 900 for image processing according to implementations of the present disclosure. At a block 910, obtaining a reference dataset that comprises a plurality of reference samples, a reference sample in the plurality of reference samples comprising: a reference image and a reference label corresponding to the reference image, the reference label indicating a processing result of the image processing. At a block 920, determining an influence of the reference dataset on a loss for updating an image model associated with the image processing based on the plurality reference samples, the image model representing an association relationship between an image and a processing result of the image processing. At a block 930, determining a hyperparameter for updating the image model based on the influence of the reference dataset. At a block 940, updating the image model based on the hyperparameter, the loss, and the plurality of reference samples.

In implementations of the present disclosure, determining the influence of the reference dataset on the loss comprises: obtaining a reference matrix based on the reference dataset, the reference dataset comprising a plurality of dimensions corresponding to the plurality of reference samples respectively, a dimension in the plurality of dimension comprising: an image feature corresponding to the reference image comprised in the reference sample and a label feature corresponding the reference label comprised in the reference sample, determining a spectral property related to the reference matrix, the spectral property comprising any of: a trace related to the reference matrix or an eigenvalue related to the reference matrix; and determining the influence of the reference dataset based on the spectral property of the reference matrix.

In implementations of the present disclosure, obtaining the reference matrix based on the reference dataset comprises: determining a plurality of influences of the plurality of reference samples on the loss, respectively; and obtaining the reference matrix related to the dataset based on the plurality of influences of the plurality of reference samples.

In implementations of the present disclosure, the hyperparameter comprises a step size for updating the image model, and determining the step size comprising: determining a first and a second eigenvalue related to the reference matrix, the first eigenvalue being greater than the second eigenvalue; and determining the step size based on the first eigenvalue.

In implementations of the present disclosure, determining the step size further comprises: updating the step size based on a damping parameter, the damping parameter being greater than zero.

In implementations of the present disclosure, the hyperparameter comprises a batch size for updating the image model, and determining the batch size comprising: determining a trace related to the reference matrix; and determining the batch size based on the trace and the first eigenvalue related to the reference matrix.

In implementations of the present disclosure, the hyperparameter comprises a number of steps for updating the image model, and determining the number of steps comprising: determining the number of steps based on the step size and a damping parameter.

In implementations of the present disclosure, updating the image model comprises: selecting a batch of reference samples from the plurality of reference samples based on the batch size; with respect to a target reference sample in the batch of reference sample, determining a prediction of a processing result related to a target image comprised in the target reference sample based on the image model; determining a reference loss value based on the prediction and a target label comprised in the target reference sample; and updating the image model in a direction for decreasing the reference loss value according to the step size.

In implementations of the present disclosure, updating the image model comprises: determining a number of iterations that the image model is updated; and updating the image model in response to determining that the number of iterations being below the number of steps.

In implementations of the present disclosure, the image processing comprises any of: image classification, image analysis, image enhancement, image segmentation, object detection, image style conversation, and image generation.

According to implementations of the present disclosure, an apparatus is provided for image processing. The apparatus comprises: an obtaining unit, being configured for obtaining a reference dataset that comprises a plurality of reference samples, a reference sample in the plurality of reference samples comprising: a reference image and a reference label corresponding to the reference image, the reference label indicating a processing result of the image processing; an influence determining unit, being configured for determining an influence of the reference dataset on a loss for updating an image model associated with the image processing based on the plurality reference samples, the image model representing an association relationship between an image and a processing result of the image processing; a hyperparameter determining unit, being configured for determining a hyperparameter for updating the image model based on the influence of the reference dataset; and an updating unit, being configured for updating the image model based on the hyperparameter, the loss, and the plurality of reference samples. Further, the apparatus may comprise other units for implementing other steps in the method 900.

According to implementations of the present disclosure, an electronic device is provided for implementing the method 900. The electronic device comprises: a computer processor coupled to a computer-readable memory unit, the memory unit comprising instructions that when executed by the computer processor implements a method for image processing. The method comprises: obtaining a reference dataset that comprises a plurality of reference samples, a reference sample in the plurality of reference samples comprising: a reference image and a reference label corresponding to the reference image, the reference label indicating a processing result of the image processing; determining an influence of the reference dataset on a loss for updating an image model associated with the image processing based on the plurality reference samples, the image model representing an association relationship between an image and a processing result of the image processing; determining a hyperparameter for updating the image model based on the influence of the reference dataset; and updating the image model based on the hyperparameter, the loss, and the plurality of reference samples.

In implementations of the present disclosure, determining the influence of the reference dataset on the loss comprises: obtaining a reference matrix based on the reference dataset, the reference dataset comprising a plurality of dimensions corresponding to the plurality of reference samples respectively, a dimension in the plurality of dimension comprising: an image feature corresponding to the reference image comprised in the reference sample and a label feature corresponding the reference label comprised in the reference sample, determining a spectral property related to the reference matrix, the spectral property comprising any of: a trace related to the reference matrix or an eigenvalue related to the reference matrix; and determining the influence of the reference dataset based on the spectral property of the reference matrix.

In implementations of the present disclosure, obtaining the reference matrix based on the reference dataset comprises: determining a plurality of influences of the plurality of reference samples on the loss, respectively; and obtaining the reference matrix related to the dataset based on the plurality of influences of the plurality of reference samples.

In implementations of the present disclosure, the hyperparameter comprises a step size for updating the image model, and determining the step size comprising: determining a first and a second eigenvalue related to the reference matrix, the first eigenvalue being greater than the second eigenvalue; and determining the step size based on the first eigenvalue.

In implementations of the present disclosure, determining the step size further comprises: updating the step size based on a damping parameter, the damping parameter being greater than zero.

In implementations of the present disclosure, the hyperparameter comprises a batch size for updating the image model, and determining the batch size comprising: determining a trace related to the reference matrix; and determining the batch size based on the trace and the first eigenvalue related to the reference matrix.

In implementations of the present disclosure, the hyperparameter comprises a number of steps for updating the image model, and determining the number of steps comprising: determining the number of steps based on the step size and a damping parameter.

In implementations of the present disclosure, updating the image model comprises: selecting a batch of reference samples from the plurality of reference samples based on the batch size; with respect to a target reference sample in the batch of reference sample, determining a prediction of a processing result related to a target image comprised in the target reference sample based on the image model; determining a reference loss value based on the prediction and a target label comprised in the target reference sample; and updating the image model in a direction for decreasing the reference loss value according to the step size.

In implementations of the present disclosure, updating the image model comprises: determining a number of iterations that the image model is updated; and updating the image model in response to determining that the number of iterations being below the number of steps.

In implementations of the present disclosure, the image processing comprises any of: image classification, image analysis, image enhancement, image segmentation, object detection, image style conversation, and image generation.

According to implementations of the present disclosure, a computer program product, the computer program product comprising a computer readable storage medium having program instructions embodied therewith, the program instructions executable by an electronic device to cause the electronic device to perform the method 900.

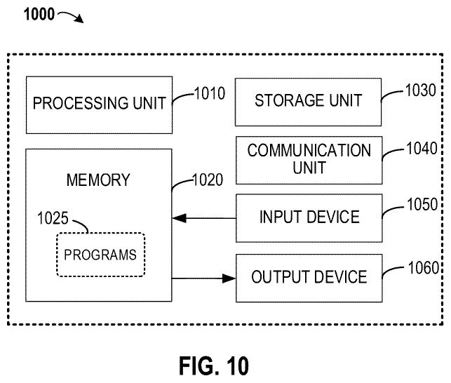

FIG. 10 illustrates a block diagram of a computing device 1000 in which various implementations of the present disclosure can be implemented. It would be appreciated that the computing device 1000 shown in FIG. 10 is merely for purpose of illustration, without suggesting any limitation to the functions and scopes of the present disclosure in any manner. The computing device 1000 may be used to implement the above method 1000 in implementations of the present disclosure. As shown in FIG. 10, the computing device 1000 may be a general-purpose computing device. The computing device 1000 may at least comprise one or more processors or processing units 1010, a memory 1020, a storage unit 1030, one or more communication units 1040, one or more input devices 1050, and one or more output devices 1060.

The processing unit 1010 may be a physical or virtual processor and can implement various processes based on programs stored in the memory 1020. In a multi-processor system, multiple processing units execute computer executable instructions in parallel so as to improve the parallel processing capability of the computing device 1000. The processing unit 1010 may also be referred to as a central processing unit (CPU), a microprocessor, a controller, or a microcontroller.

The computing device 1000 typically includes various computer storage medium. Such medium can be any medium accessible by the computing device 1000, including, but not limited to, volatile and non-volatile medium, or detachable and non-detachable medium. The memory 1020 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1030 may be any detachable or non-detachable medium and may include a machine-readable medium such as a memory, flash memory drive, magnetic disk, or another other media, which can be used for storing information and/or data and can be accessed in the computing device 1000.

The computing device 1000 may further include additional detachable/non-detachable, volatile/non-volatile memory medium. Although not shown in FIG. 10, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1040 communicates with a further computing device via the communication medium. In addition, the functions of the components in the computing device 1000 can be implemented by a single computing cluster or multiple computing machines that can communicate via communication connections. Therefore, the computing device 1000 can operate in a networked environment using a logical connection with one or more other servers, networked personal computers (PCs) or further general network nodes.

The input device 1050 may be one or more of a variety of input devices, such as a mouse, keyboard, tracking ball, voice-input device, and the like. The output device 1060 may be one or more of a variety of output devices, such as a display, loudspeaker, printer, and the like. By means of the communication unit 1040, the computing device 1000 can further communicate with one or more external devices (not shown) such as the storage devices and display device, with one or more devices enabling the user to interact with the computing device 1000, or any devices (such as a network card, a modem, and the like) enabling the computing device 1000 to communicate with one or more other computing devices, if required. Such communication can be performed via input/output (I/O) interfaces (not shown).

In some implementations, instead of being integrated in a single device, some, or all components of the computing device 1000 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

1. A method for image processing, comprising:
obtaining a reference dataset that comprises a plurality of reference samples, a reference sample in the plurality of reference samples comprising: a reference image and a reference label corresponding to the reference image, the reference label indicating a processing result of the image processing;
determining an influence of the reference dataset on a loss for updating an image model associated with the image processing based on the plurality reference samples, the image model representing an association relationship between an image and a processing result of the image processing;
determining a hyperparameter for updating the image model based on the influence of the reference dataset; and
updating the image model based on the hyperparameter, the loss, and the plurality of reference samples.

2. The method of claim 1, wherein determining the influence of the reference dataset on the loss comprises:
obtaining a reference matrix based on the reference dataset, the reference dataset comprising a plurality of dimensions corresponding to the plurality of reference samples respectively, a dimension in the plurality of dimension comprising: an image feature corresponding to the reference image comprised in the reference sample and a label feature corresponding the reference label comprised in the reference sample,
determining a spectral property related to the reference matrix, the spectral property comprising any of: a trace related to the reference matrix or an eigenvalue related to the reference matrix; and
determining the influence of the reference dataset based on the spectral property of the reference matrix.

3. The method of claim 2, wherein obtaining the reference matrix based on the reference dataset comprises:
determining a plurality of influences of the plurality of reference samples on the loss, respectively; and
obtaining the reference matrix related to the dataset based on the plurality of influences of the plurality of reference samples.

4. The method of claim 3, wherein the hyperparameter comprises a step size for updating the image model, and determining the step size comprising:
determining a first and a second eigenvalue related to the reference matrix, the first eigenvalue being greater than the second eigenvalue; and
determining the step size based on the first eigenvalue.

5. The method of claim 4, wherein determining the step size further comprises: updating the step size based on a damping parameter, the damping parameter being greater than zero.

6. The method of claim 4, wherein the hyperparameter comprises a batch size for updating the image model, and determining the batch size comprising:
determining a trace related to the reference matrix; and
determining the batch size based on the trace and the first eigenvalue related to the reference matrix.

7. The method of claim 6, wherein the hyperparameter comprises a number of steps for updating the image model, and determining the number of steps comprising: determining the number of steps based on the step size and a damping parameter.

8. The method of claim 7, wherein updating the image model comprises:
selecting a batch of reference samples from the plurality of reference samples based on the batch size;
with respect to a target reference sample in the batch of reference sample, determining a prediction of a processing result related to a target image comprised in the target reference sample based on the image model;
determining a reference loss value based on the prediction and a target label comprised in the target reference sample; and
updating the image model in a direction for decreasing the reference loss value according to the step size.

9. The method of claim 7, wherein updating the image model comprises:
determining a number of iterations that the image model is updated; and
updating the image model in response to determining that the number of iterations being below the number of steps.

10. The method of claim 1, wherein the image processing comprises any of: image classification, image analysis, image enhancement, image segmentation, object detection, image style conversation, and image generation.

11. An electronic device, comprising a computer processor coupled to a computer-readable memory unit, the memory unit comprising instructions that when executed by the computer processor implements a method for image processing, the method comprising:
obtaining a reference dataset that comprises a plurality of reference samples, a reference sample in the plurality of reference samples comprising: a reference image and a reference label corresponding to the reference image, the reference label indicating a processing result of the image processing;
determining an influence of the reference dataset on a loss for updating an image model associated with the image processing based on the plurality reference samples, the image model representing an association relationship between an image and a processing result of the image processing;
determining a hyperparameter for updating the image model based on the influence of the reference dataset; and
updating the image model based on the hyperparameter, the loss, and the plurality of reference samples.

12. The device of claim 11, wherein determining the influence of the reference dataset on the loss comprises:
obtaining a reference matrix based on the reference dataset, the reference dataset comprising a plurality of dimensions corresponding to the plurality of reference samples respectively, a dimension in the plurality of dimension comprising: an image feature corresponding to the reference image comprised in the reference sample and a label feature corresponding the reference label comprised in the reference sample,
determining a spectral property related to the reference matrix, the spectral property comprising any of: a trace related to the reference matrix or an eigenvalue related to the reference matrix; and
determining the influence of the reference dataset based on the spectral property of the reference matrix.

13. The device of claim 12, wherein obtaining the reference matrix based on the reference dataset comprises:
determining a plurality of influences of the plurality of reference samples on the loss, respectively; and
obtaining the reference matrix related to the dataset based on the plurality of influences of the plurality of reference samples.

14. The device of claim 13, wherein the hyperparameter comprises a step size for updating the image model, and determining the step size comprising:
determining a first and a second eigenvalue related to the reference matrix, the first eigenvalue being greater than the second eigenvalue;
determining the step size based on the first eigenvalue; and
updating the step size based on a damping parameter, the damping parameter being greater than zero.

15. The device of claim 14, wherein the hyperparameter comprises a batch size for updating the image model, and determining the batch size comprising:
determining a trace related to the reference matrix; and
determining the batch size based on the trace and the first eigenvalue related to the reference matrix.

16. The device of claim 15, wherein the hyperparameter comprises a number of steps for updating the image model, and determining the number of steps comprising: determining the number of steps based on the step size and a damping parameter.

17. The device of claim 16, wherein updating the image model comprises:
selecting a batch of reference samples from the plurality of reference samples based on the batch size;
with respect to a target reference sample in the batch of reference sample,
determining a prediction of a processing result related to a target image comprised in the target reference sample based on the image model;
determining a reference loss value based on the prediction and a target label comprised in the target reference sample; and
updating the image model in a direction for decreasing the reference loss value according to the step size.

18. The device of claim 16, wherein updating the image model comprises:
determining a number of iterations that the image model is updated; and
updating the image model in response to determining that the number of iterations being below the number of steps.

19. The device of claim 11, wherein the image processing comprises any of: image classification, image analysis, image enhancement, image segmentation, object detection, image style conversation, and image generation.

20. A non-transitory computer program product, the non-transitory computer program product comprising a computer readable storage medium having program instructions embodied therewith, the program instructions executable by an electronic device to cause the electronic device to perform a method for image processing, the method comprising:
obtaining a reference dataset that comprises a plurality of reference samples, a reference sample in the plurality of reference samples comprising: a reference image and a reference label corresponding to the reference image, the reference label indicating a processing result of the image processing;
determining an influence of the reference dataset on a loss for updating an image model associated with the image processing based on the plurality reference samples, the image model representing an association relationship between an image and a processing result of the image processing;
determining a hyperparameter for updating the image model based on the influence of the reference dataset; and
updating the image model based on the hyperparameter, the loss, and the plurality of reference samples.
